(19) United States
(12) Patent Application Publication
(10) Pub. No.: US 2004/0224567 A1
(43) Pub. Date: Nov. 11, 2004

(54) Electrical connector with improved locking device

(76) Inventors: Ruiwen Zhong, Kunsan (CN); Zhiquan Mou, Kunsan (CN); Maolin Lei, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/600,586

(22) Filed: Jun. 19, 2003

(30) Foreign Application Priority Data
May 9, 2003 (TW) 92208566

(51) Int. Cl. H01R 13/502

(52) U.S. Cl. 439/701

(57) ABSTRACT

An electrical connector (1) includes a dielectric housing (10) and a terminal subassembly (2). The dielectric housing (10) includes an elongate base (11) defining a cavity: (14) in a rear face thereof. The terminal subassembly (2) is received in the cavity (14) and includes first and second terminal modules (20, 30) assembled together. Each of first and second terminal modules (20, 30) includes a dielectric body (21, 22) received in the cavity (14) and a number of terminals (22, 32) retained in the dielectric body (21, 31). The dielectric body (21, 31) has a number of swallow-tailed projections (27, 34) on a first face thereof and a number of swallow-tailed recesses (24, 37) between adjacent projections. The recesses (37) and the projections (34) of the second terminal module (30) engage with corresponding projections (27) and recesses (24) of the first terminal module (20).

### BACKGROUND OF THE INVENTION

1. Field of the Invention

The present invention relates to an electrical connector, and particularly to an electrical connector having terminal modules with an improved locking device.

2. Description of Related Art

With the requirement for high speed signal transmission of facsimile machines, printers, consumer and other computer-related electronic equipments, electrical connectors having a large number of terminals are developed to electrically connect a motherboard of the computer and periphery equipments. Commonly, the connector comprises several terminal modules by insert molding to be received in a dielectric housing thereof. In assembly, the terminal modules are firstly assembled together and then inserted into a receiving space of the dielectric housing of the connector, as disclosed in U.S. Pat. No. 6,210,218.

U.S. Pat. No. 6,210,218 discloses a connector comprising a dielectric housing and three separate terminal modules received in the dielectric housing. The terminal modules respectively have holes and posts for interferencally engaging with each other to lock the terminal modules together. The connector is mounted onto a printed circuit board (PCB) by through hole technology (THT). However, if the connector needs to be mounted onto the PCB by other method such as straddle surface mounted technology (SMT), due to unreliable engagement between posts and the holes of the terminal modules, the terminal modules are apt to separate from each other along a vertical direction during the procedure of SMT.

Hence, an electrical connector having terminal modules with an improved locking device is desired to overcome the disadvantages and problems of the prior art.

### SUMMARY OF THE INVENTION

An object of the present invention is to provide an electrical connector having terminal modules with an improved locking device.

To achieve the above object, an electrical connector in accordance with the present invention comprises a dielectric housing and a terminal subassembly. The dielectric housing comprises an elongate base having a rear face and a mating portion extending from the base. The base defines a cavity in the rear face thereof and the mating portion defines a receiving space in a mating face thereof to communicate with the cavity. The terminal subassembly is received in the cavity and comprises first and second terminal modules assembled together. Each of first and second terminal modules comprises a dielectric body received in the cavity and a plurality of terminals retained in the dielectric body. Each terminal comprises a retaining portion received in the dielectric body, a contacting portion extending into the receiving space and a tail portion extending beyond the rear face of the base. The dielectric body of the first terminal module comprises a first face and a plurality of projections formed on the first face thereof. The dielectric body of the second terminal module comprises a first face and a plurality of recesses on the first face thereof engaging with the corresponding projections of the first terminal module. A width of each projection gradually increases from a first position adjacent to the first face of the dielectric body of the first terminal module to a second position adjacent to a top face of the projection.

Other objects, advantages and novel features of the invention will become more apparent from the following detailed description when taken in conjunction with the accompanying drawings.

### BRIEF DESCRIPTION OF THE DRAWINGS

FIG. 1 is a front perspective view of an electrical connector in accordance with the present invention;

FIG. 2 is a rear perspective view of the connector shown in FIG. 1;

FIG. 3 is an exploded view of the connector shown in FIG. 2;

FIG. 4 is an enlarged and exploded perspective view of a terminal subassembly of the connector of FIG. 3 wherein the second terminal module is upside down and further reversely relative to the first terminal module to show the dovetail joint therebetween;

FIG. 5 is an assembled view of the terminal subassembly of FIG. 4;

FIG. 6 is a cross-sectional view taken along line 6-6 of FIG. 2; and

FIG. 7 is a schematically cross-sectional view of the terminal subassembly, showing a first terminal module separated from a second terminal module.

### DETAILED DESCRIPTION OF THE PREFERRED EMBODIMENT

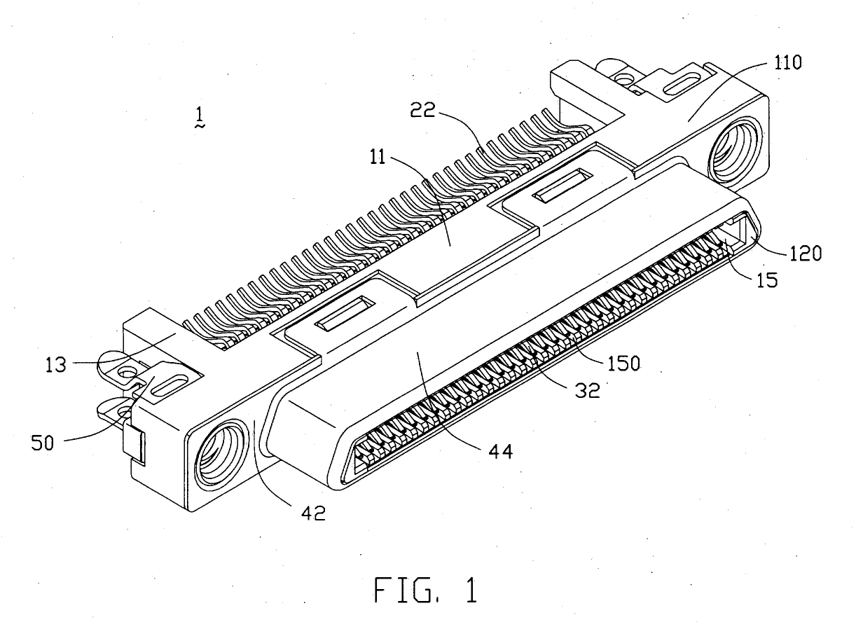

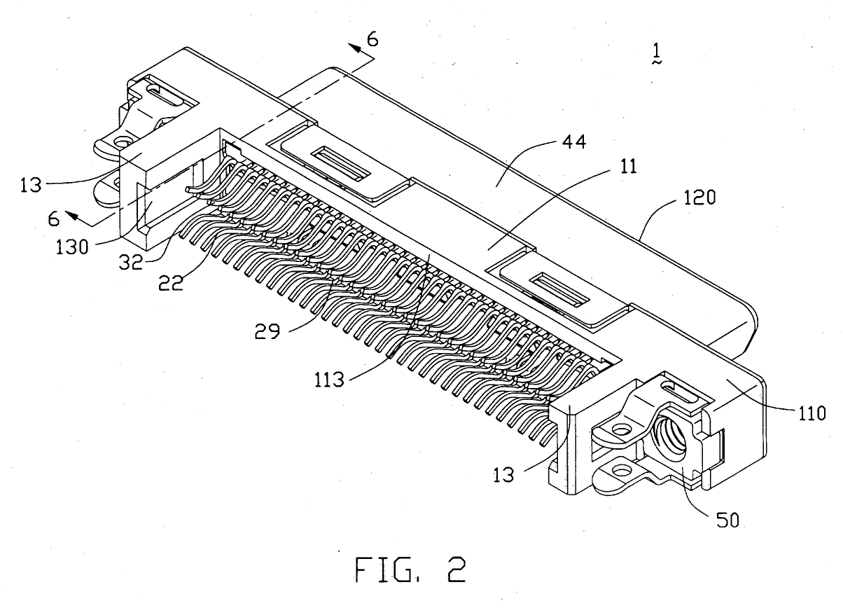

Referring to FIGS. 1-3, an electrical connector 1 in accordance with the present invention comprises a dielectric housing 10, a terminal subassembly 2 received in the dielectric housing 10, a metallic shield 40 enclosing the dielectric housing 10 and a pair of board locks 50 retained to the dielectric housing 10 and electrically connecting with the shield 40.

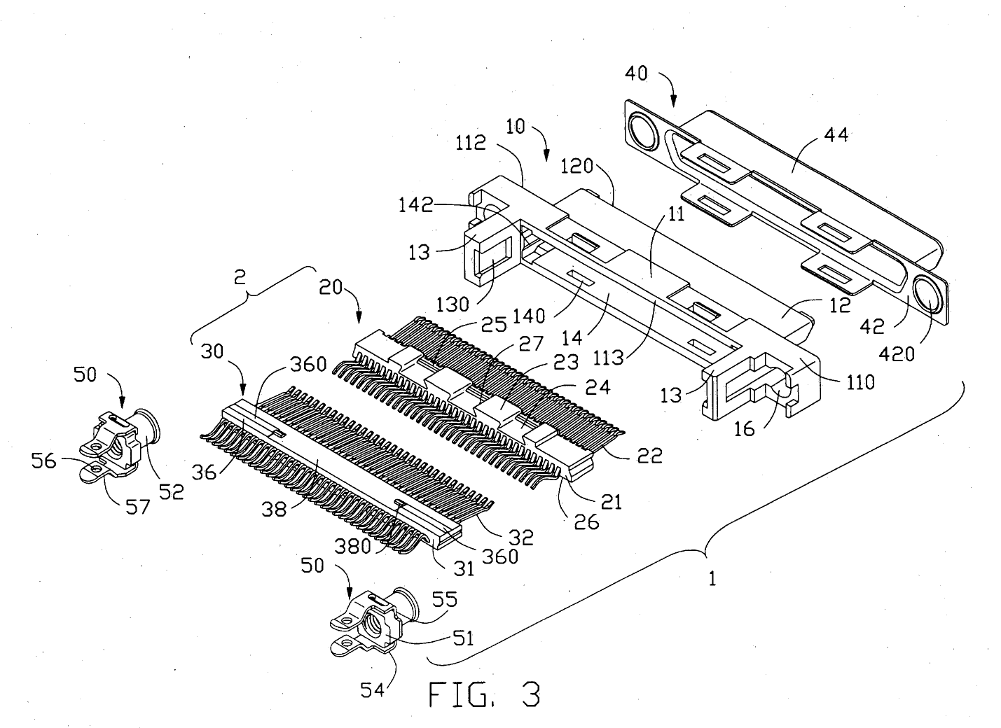

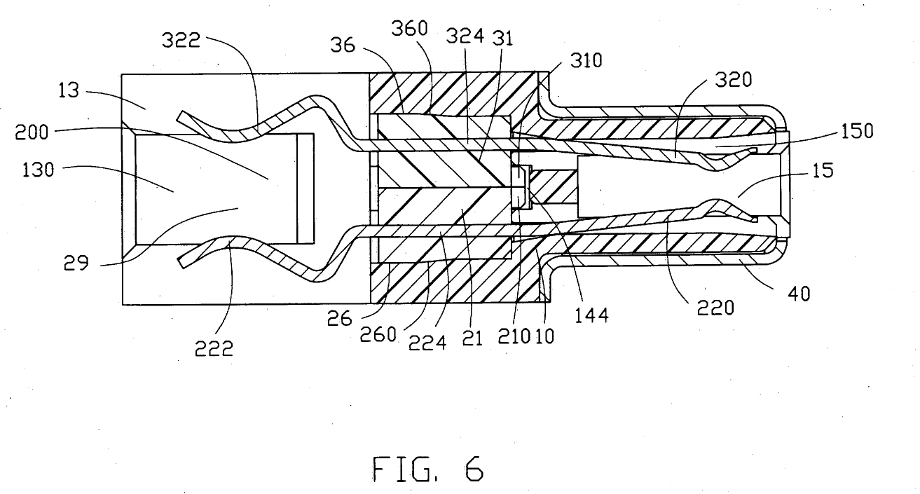

Referring to FIG. 3, the dielectric housing 10 comprises an elongate base 11 having a top face 110, a bottom face 111 opposite to the top face 110, and opposite front and rear faces 112, 113 interconnecting the top and bottom faces 110, 111. The dielectric housing 10 also comprises a mating portion 12 extending forwardly from the front face 112 of the base 11 and having a mating face 120. The mating portion 12 defines a receiving space 15 extending from the mating face 120 for receiving a mating portion of a complementary connector (not shown) and a plurality of channels 150 respectively in opposite upper and lower walls of the receiving space 15. The base 11 defines a cavity 14 in the rear face 113 and communicating with the receiving space 15 through the channels 150. The base 11 is formed with a pair of ribs 142 respectively on opposite inner sides of the cavity 14 and defines a plurality of holes 140 respectively in upper and lower walls of the cavity 14. The base 11 defines a plurality of recesses 144 (shown in FIG. 6) communicating with the cavity 14. The dielectric housing 10 comprises a pair of arms 13 extending rearwardly from opposite sides of the rear face 113 and located beside the cavity 14. The arms 13 define a pair of grooves 130 in opposite inner sides thereof, respectively. The base 11 defines a pair of openings 16 penetrating therethrough at opposite ends thereof.

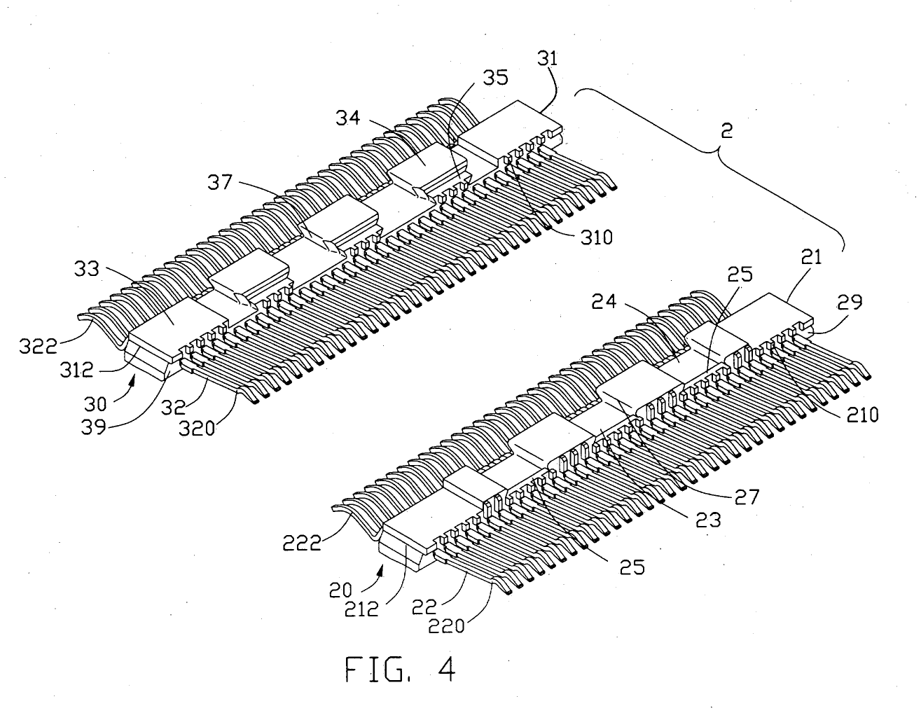

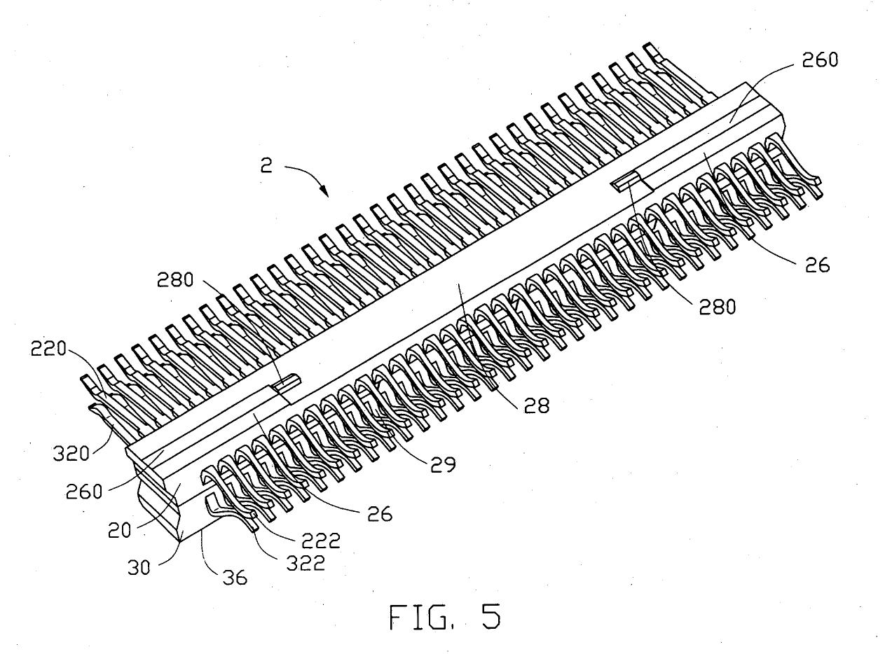

Referring to FIGS. 4-7, the terminal subassembly 2 is received in the cavity 14 of the dielectric housing 10 and comprises a first terminal module 20 and a second terminal module 30 stacked on the first terminal module 20. Each terminal module 20, 30 comprises a dielectric body 21, 31 and a plurality of terminals 22, 32 retained in the dielectric body 21, 31. Each dielectric body 21, 31 has a first face 23, 33, a second face 28, 38 opposite to the first face 23, 33 for abutting against the upper wall or lower wall of the cavity 14 and a front face 29, 39 interconnecting the first face 23, 33 with the second face 28, 38. The dielectric body 21, 31 is formed with a protrusion 280, 380 on the second face 28, 38 to be received in the corresponding hole 140 of the base 11, a wedge portion 26, 36 on the second face 28, 38 having a wedged face 260, 360 for interferentially engaging with one of the upper and lower walls of the cavity 14, and a plurality of bulges 210, 310 on the front face 29, 39 thereof. A pair of vertically aligned bulges 210 of the first dielectric body 21 and the second dielectric body 31 is received in the corresponding recess 144 of the dielectric housing 10, thereby ensuring an engagement between the terminal subassembly 2 and the dielectric housing 10. The dielectric body 21, 31 defines a pair of dents 212, 312 at opposite sides thereof. The dent 212 of the first dielectric body 21 and the corresponding dents 312 of the second dielectric body 31 commonly form a slot to receive the corresponding rib 142 of the base 11 therein.

Each terminal 22, 32 comprises a retaining portion 224, 324 received in the dielectric body 21, 31 by insert molding, a contacting portion 220, 320 extending forwardly from the front face 29, 39 of the dielectric body 21, 31 and received in the corresponding channel 150 of the mating portion 12, and a tail portion 222, 322 extending rearwardly from the retaining portion 224, 324. A receiving space 200 is defined between the tail portions 222 of the first terminals 22 and the tail portion 322 of the second terminals 32 for receiving a printed circuit board therein and the tail portions 222, 322 are electrically connected with the PCB by SMT.

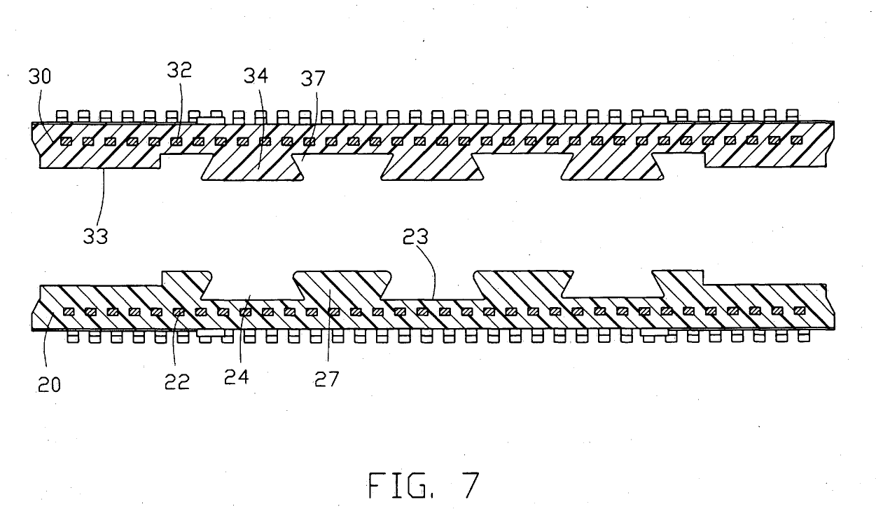

Further referring to FIGS. 4 and 7, the first dielectric body 21 comprises a plurality of dove-tail shaped projections 27 on the first face 23 thereof. The width of each projection 27 gradually increases from a first position adjacent to the first face 23 to a second position adjacent to a top face of the projection 27. The second dielectric body 31 defines a plurality of recesses 37 in the first face 33 thereof receiving the corresponding projection 27 of the first dielectric body 21. A dove-tail shaped recess 24 is defined between every two adjacent projections 27 of the first dielectric body 21. The second dielectric body 31 is formed with a dove-tail shaped projection 34 between every two adjacent recesses 37 thereof to engage with the corresponding recess 24 of the first dielectric body 21. The first dielectric body 21 is formed with a plurality of protrusions 25 on the recesses 24 adjacent to the front face 29 thereof. Each projection 34 of the second dielectric body 31 defines a cutout 35 adjacent to the front face 39 for engaging with the protrusion 25 of the dielectric body 21. In assembly, the recesses 24 and the projections 27 of the first dielectric body 21 engage with the corresponding projections 34 and the corresponding recesses 37 of the second dielectric body 31, thereby securing the engagement between the first and second terminal modules 20, 30. More importantly, the projections 27, 34 and recesses 24, 37 of swallow-tailed shape provide a retaining force in vertical direction between the first and second terminal modules 20, 30.

Referring back to FIG. 3, the shield 40 comprises a plate 42 enclosing the front face 112 of the base 11 and a shroud frame 44 enclosing the engaging portion 12. The plate 42 defines a pair of holes 420 corresponding to the openings 16 of the base 11. The board lock 50 comprises a rectangular body 51, a post 52 extending forwardly from the body 51 to pass through the opening 16 of the base 11 and the hole 420 of the shield 40 to rivet the shield 40 to the housing 10 and a spring tab 54. The spring tab 54 comprises a plate 55 abutting against an inner face of the body 51 and defining an opening (not shown) which the post 52 pass though, and a pair of resilient legs 57 extending rearwardly from opposite upper and lower ends of the plate 55. The resilient leg 57 defines a hole 56 for mechanically soldering to and electrically connecting with grounding circuit of the PCB by SMT.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
a dielectric housing comprising an elongate base having a rear face and a mating portion extending from the base and having a mating face, the base defining a cavity open to the rear face, the mating portion defining a receiving space open to the mating face and in communicating with the cavity; and
a terminal subassembly comprising a first and a second terminal modules stacked together, each of the first and the second terminal modules comprising a dielectric body received in the cavity and a plurality of terminals, each terminal comprising a retaining portion received in the dielectric body, a contacting portion extending into the receiving space and a tail portion extending beyond the rear face of the base, the dielectric body of the first terminal module comprising a first face and a plurality of projections formed on the first face thereof, the dielectric body of the second terminal module comprising a first face and a plurality of recesses on the first face thereof engaging with the corresponding projections of the first terminal module; wherein
a width of each projection gradually increases from a first position adjacent to the first face of the dielectric body of the first terminal module to a second position adjacent to a top face of the projection.

2. The electrical connector as claimed in claim 1, wherein the dielectric body of the first terminal modules defines a plurality of recesses between two adjacent projections thereof, and wherein the dielectric body of the second terminal module comprises a plurality of projections between two adjacent recesses thereof engaging with the recesses of the first terminal module.

3. The electrical connector as claimed in claim 1, wherein the projections of the first and the second terminal module are dove-tail shaped.

4. The electrical connector as claimed in claim 3, wherein the dielectric body of the first terminal module is formed with a protrusion in each recess thereof and wherein the dielectric body of the second terminal module defines a cutout on each projection thereof to engage with a corresponding protrusion of the first terminal module.

5. The electrical connector as claimed in claim 1, wherein each dielectric body comprises a wedged second face opposite to the first face thereof to interferentially engage with a corresponding wall of the cavity.

6. The electrical connector as claimed in claim 1, wherein the base defines a plurality of holes in two opposite inside walls of the cavity, and wherein the dielectric bodies of the first and the second terminals comprise a plurality of protrusions on the second face thereof to engage with the holes of the base.

7. The electrical connector as claimed in claim 1, wherein the base of the dielectric housing comprises a pair of ribs on two opposite inside walls of the cavity, and wherein each dielectric body comprises a pair of dents at opposite sides thereof, each one of dents of the first terminal module and the corresponding one of dents of the second terminal module form a slot to receive the corresponding rib of the base.

8. The electrical connector as claimed in claim 1, wherein the mating portion defines a plurality of channels in two opposite inside walls of the receiving space, and wherein the contacting portions of the terminals are received in the channels.

9. The electrical connector as claimed in claim 1, wherein the base defines a plurality of recesses communicating with the cavity, and wherein each dielectric body defines a plurality of bulges engaging with corresponding recesses of the base.

10. The electrical connector as claimed in claim 1, wherein the terminals are insert-molded in associated dielectric body.

11. An electrical connector comprising:
an insulative housing defining a cavity in a rear portion and a receiving space in a front portion and in communication with said cavity;
a terminal subassembly inserted into said cavity and including a plurality of terminal modules stacked on one another, each of said terminal modules extending along a lengthwise direction and retaining therein a plurality of terminals which extend into the receiving space, an interface between the two adjacent terminal modules being equipped with a structure of dovetail joint so as to allow assembling of said two adjacent terminal modules only along a front-to-back direction perpendicular to said lengthwise direction and be unable to be separated from each other in a vertical direction perpendicular to both said lengthwise direction and said front-to-back direction.
